(19) United States
(12) Patent Application Publication
(10) Pub. No.: US 2024/0112117 A1
(43) Pub. Date: Apr. 4, 2024

(54) SAAS APPLICATION FEATURE BENCHMARKING IN A SAAS MANAGEMENT PLATFORM

(71) Applicant: Productiv, Inc., Palo Alto, CA (US)

(72) Inventors: Suresh Parameshwar, Redmond, WA (US); Mengsu Chen, Kirkland, WA (US); Ashish Aggarwal, Los Altos Hills, CA (US)

(21) Appl. No.: 17/958,263

(22) Filed: Sep. 30, 2022

(51) Int. Cl. G06Q 10/06; G06F 9/54

(52) U.S. Cl. CPC G06Q 10/06393; G06F 9/543

(57) ABSTRACT

A software as a service (SaaS) management platform, includes: a plurality of connectors configured to access a respective plurality of SaaS applications, wherein said connectors are used to obtain customer event data from SaaS applications to which customers subscribe; an aggregation job that periodically aggregates the event data for each SaaS application over a moving time window to generate customer usage data indicating use of SaaS application features; a benchmark background job that anonymizes the customer usage data for the SaaS applications across the plurality of customers of the SMP to generate anonymized usage data; a benchmark backend that, responsive to a request from a client device, reads the anonymized usage data for a given SaaS application, defines a cohort of anonymized customers, generates benchmarks defining median use of respective features of the given SaaS application by the anonymized customers, and returns the benchmarks to the client device.

### BACKGROUND

### 1. Field of the Disclosure

The present disclosure relates to SaaS application feature benchmarking in a SaaS management platform.

### 2. Description of the Related Art

Software as a service (SaaS) is a software distribution model in which applications are cloud-hosted and made available to end users over the Internet. This is advantageous for the end users in that a SaaS application is provided “as a service,” such that the end users are not required to host or maintain the application, and are enabled to access the application from practically anywhere with sufficient network connectivity. However, the rise of SaaS adoption amongst corporate entities also presents problems from a management perspective. As a given corporate entity may subscribe to many different SaaS applications, efficient SaaS management becomes increasingly difficult as a result.

It is in this context that implementations of the disclosure arise.

### SUMMARY

Implementations of the present disclosure include methods and systems relating to SaaS application feature benchmarking in a SaaS management platform.

In some implementations, a software as a service (SaaS) management platform (SMP) implemented in a cloud resource having at least one server computer and at least one storage device is provided, the SMP being accessible over the Internet by a plurality of customers that subscribe to the SMP, the SMP including: a plurality of connectors configured to access customer data from a respective plurality of SaaS applications, wherein for each customer of the SMP, said connectors are used to obtain customer event data for each SaaS application to which the customer is subscribed; an aggregation job that, for each customer of the SMP, periodically aggregates the event data for each SaaS application over a moving time window to generate customer usage data indicating customer use of features of each SaaS application; a benchmark background job that, for each of the plurality of SaaS applications, obtains and anonymizes the customer usage data for the SaaS application across the plurality of customers of the SMP to generate anonymized usage data that is grouped by SaaS application; a benchmark backend that, responsive to a request received over the Internet from a client device, reads the anonymized usage data for a given SaaS application, defines a cohort of anonymized customers in the anonymized usage data, generates one or more benchmarks defining median use of one or more respective features of the given SaaS application by the anonymized customers of the cohort, and returns the benchmarks to the client device.

In some implementations, the use of a given feature is defined by a fraction or percentage of licensed users of a customer that used the feature during the moving time window, such that the benchmark for the given feature identifies a median fraction or percentage of licensed users, for an anonymized customer of the cohort, that used the feature during the moving time window.

In some implementations, the use of a given feature is defined by a number of times licensed users of a customer used the feature during the moving time window, such that the benchmark for the given feature identifies a median number of times licensed users, for an anonymized customer of the cohort, used the feature during the moving time window.

In some implementations, the moving time window is configured so that each successive aggregation performed by the aggregation job aggregates event data over an equivalent and overlapping duration of time to that of a preceding aggregation performed by the aggregation job.

In some implementations, the moving time window is defined by a predefined number of days preceding a current date.

In some implementations, the client device is associated to a user of a given customer, the request being generated through interactivity with a user interface rendered by the client device, said user interface is configured to display the customer usage data of the given customer for the features of the SaaS application.

In some implementations, the benchmarks are configured to be rendered in the user interface with the customer usage data of the given customer.

In some implementations, the cohort of anonymized customers is determined based on one or more characteristics of the given customer.

In some implementations, the user interface is configured to be rendered in a web browser.

In some implementations, the cohort of anonymized customers is defined by anonymized customers having greater than a predefined number of licenses for the SaaS application.

In some implementations, generating the one or more benchmarks includes filtering outliers from the anonymized usage data of the cohort.

In some implementations, at least one of the plurality of connectors is configured to access an API of a respective SaaS application.

In some implementations, anonymizing the obtained customer usage data includes removing customer names from the customer usage data, assigning each customer a unique identifier, and retaining characteristics of each customer in the customer usage data.

In some implementations, a software as a service (SaaS) management platform (SMP) implemented on one or more server computers is provided, including: a connector that, for each of a plurality of customer organizations of the SMP, obtains, over a network from a SaaS application, event data identifying events that occurred through use of the SaaS application; an aggregation job that periodically aggregates the event data for each of the customer organizations occurring during a rolling time window, to generate customer usage data for each customer organization, the customer usage data indicating usage amounts of features of the SaaS application by each customer organization during said rolling time window; a benchmark background job that obtains the customer usage data for each of the customer organizations, and anonymizes said obtained customer usage data, and stores the anonymized usage data in association with the SaaS application; a benchmark backend that receives, over the network, a request for feature benchmarks from a client device accessing the SMP over the network, and responsive to the request, retrieves the anonymized usage data, identifies a cohort of anonymized customer organizations from the anonymized usage data, determines the feature benchmarks which identify usage of the features of the SaaS application by the cohort of anonymized customer organizations based on a corresponding subset of the anonymized usage data, and responsive to the request transmits the feature benchmarks over the network to the client device.

In some implementations, the feature benchmarks identify a median or average use of each of the features of the SaaS application during the rolling time window.

In some implementations, the use of a given feature is defined by a fraction or percentage of licensed users of a customer organization that used the feature during the rolling time window, such that the feature benchmark for the given feature identifies a median or average fraction or percentage of licensed users, for an anonymized customer organization of the cohort, that used the feature during the rolling time window.

In some implementations, the use of a given feature is defined by a number of times licensed users of a customer organization used the feature during the rolling time window, such that the feature benchmark for the given feature identifies a median or average number of times licensed users, for an anonymized customer organization of the cohort, used the feature during the rolling time window.

In some implementations, the rolling time window is configured so that each successive periodic aggregation by the aggregation job aggregates event data over an equivalent and overlapping duration of time to that of a preceding periodic aggregation by the aggregation job.

In some implementations, the rolling time window is defined by a predefined number of days preceding a current date.

In some implementations, the client device is associated to a user of a given customer organization, the request being generated through interactivity with a user interface rendered by the client device, said user interface is configured to display the customer usage data of the given customer organization for the features of the SaaS application.

In some implementations, the feature benchmarks are configured to be rendered in the user interface with the customer usage data of the given customer organization.

In some implementations, the cohort of anonymized customer organizations is determined based on one or more characteristics of the given customer organization.

In some implementations, the user interface is configured to be rendered in a web browser.

In some implementations, the cohort of anonymized customer organizations is defined by anonymized customer organizations having greater than a predefined number of licenses for the SaaS application.

In some implementations, determining the feature benchmarks includes filtering outliers from the subset of the anonymized usage data.

In some implementations, anonymizing the obtained customer usage data includes removing customer organization names from the customer usage data, assigning each customer organization a unique identifier, and retaining characteristics of each customer organization in the customer usage data.

In some implementations, a software as a service (SaaS) management platform (SMP) implemented in a cloud resource having at least one server computer and at least one storage device is provided, the SMP being accessible over the Internet by a plurality of customers that utilize services of the SMP, the SMP comprising: a connector interface for managing access credentials to customer event data collected by a SaaS of a target customer of the SMP, the target customer event data is generated through use of the SaaS by users of the target customer; a scheduler configured to periodically trigger the connector interface to access said customer event data for the target customer and for other customers of the SMP; wherein said customer event data is processed by the SMP into customer usage data that is descriptive of use of the SaaS, an anonymizer for processing the customer usage data, the anonymizer is configured to strip customer identifying information related to the customers but retains data that is descriptive of use of the SaaS by users of the customers; a benchmarking backend that is processed responsive to a request by the target customer, the benchmarking backend is configured to access customer usage data from a cohort group of customers, the benchmarking backend producing benchmark metrics that quantify use of the SaaS by users of customers in the cohort group; wherein a user interface of the SMP provides said benchmark metrics, and further provides app metrics that quantify use of the SaaS by users of the target customer, and descriptive parameters for app metrics that are suggestive of possible optimizers available to the target customer for efficient use of the SaaS.

In some implementations, the anonymizer is configured to remove customer names in the customer usage data and assign each customer in the customer usage data a unique identifier.

In some implementations, the anonymizer is further configured to retain non-identifying characteristics of customers in the customer usage data.

In some implementations, the benchmark metrics quantify use of the SaaS by defining a median use of the SaaS or use of one or more features of the SaaS by customers in the cohort group.

In some implementations, the app metrics quantify use of the SaaS by defining a fraction or percentage of licensed users of the target customer that engaged with the SaaS or used one or more features of the SaaS.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may be better understood by reference to the following description taken in conjunction with the accompanying drawings in which:

FIG. 1 conceptually illustrates a SaaS management platform and its connection to SaaS applications, in accordance with implementations of the disclosure.

FIG. 2 conceptually illustrates aggregation of usage data in a SaaS management platform, in accordance with implementations of the disclosure.

FIG. 3 conceptually illustrates normalization of event data across a plurality of SaaS applications for storage by a SaaS management platform, in accordance with implementations of the disclosure.

FIG. 4 conceptually illustrates aggregation of event data using rolling windows to determine app usage information for a given customer organization, in accordance with implementations of the disclosure.

FIG. 5 conceptually illustrates determination of SaaS application engagement/usage benchmarks in a SaaS management platform, in accordance with implementations of the disclosure.

FIG. 6 conceptually illustrates configuration of date-related metadata as part of a benchmarking process, in accordance with implementations of the disclosure.

FIG. 7 conceptually illustrates servicing of a request to view a benchmark in a user interface of a SaaS management platform, in accordance with implementations of the disclosure.

FIG. 8 illustrates an example of a user interface for accessing customer usage data for a SaaS application, and related benchmarks, in accordance with implementations of the disclosure.

FIG. 9 illustrates an example of a user interface displaying feature-level benchmarks for a SaaS application, in accordance with implementations of the disclosure.

FIG. 10 illustrates a user interface showing a portfolio of applications for a customer of a SMP, in accordance with implementations of the disclosure.

### DETAILED DESCRIPTION

The following implementations of the present disclosure provide methods and systems relating to SaaS application feature benchmarking in a SaaS management platform.

It will be obvious, however, to one skilled in the art, that the present disclosure may be practiced without some or all of the specific details presently described. In other instances, well-known process operations have not been described in detail in order not to unnecessarily obscure the present disclosure.

Implementations of the present disclosure are implemented using a SaaS management platform (SMP). Broadly speaking, a SaaS management platform connects to, and obtains data from, a given customer's portfolio of SaaS applications, and provides analysis and insights relating to the customer's usage of their SaaS applications. One example of a SaaS management platform is Productiv™ provided by Productiv, Inc. For a fuller understanding of the present disclosure, an example of a SaaS management platform is herein described.

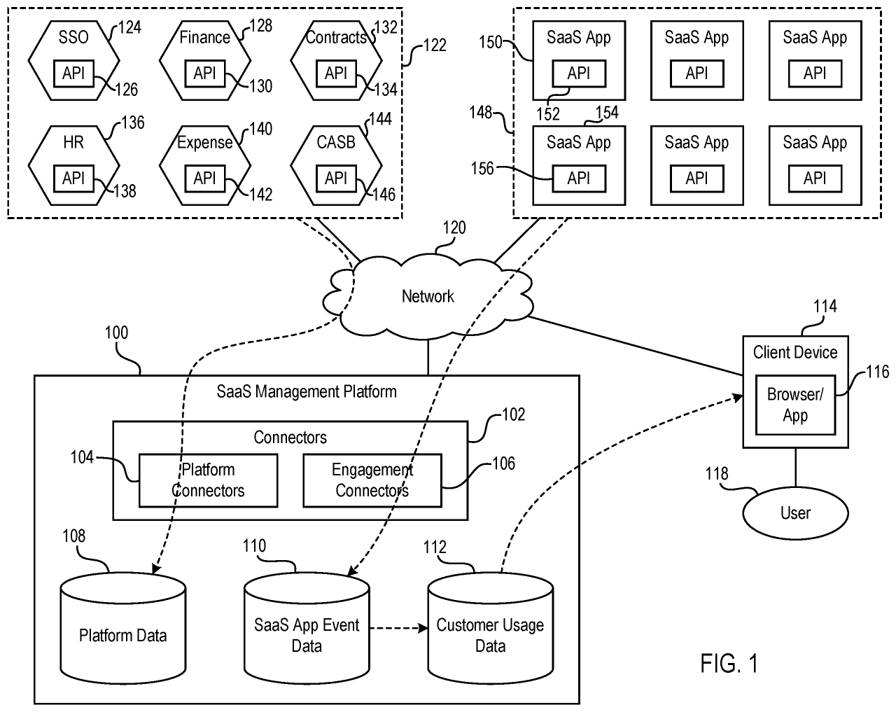

FIG. 1 conceptually illustrates a SaaS management platform and its connection to SaaS applications, in accordance with implementations of the disclosure.

In the illustrated implementation, a SaaS management platform 100 includes connectors 102 that are configured to obtain data from various applications/platforms, typically by calling their exposed Application Programming Interfaces (APIs). Connectors 102 are further distinguished between platform connectors 104 and engagement connectors 106.

Platform connectors 104 are configured to obtain data from platform applications/services 122. Broadly speaking, platform applications 122 provide contextual information to identify, enable access, and understand customer usage context of the SaaS applications which the customer is seeking to manage via the SMP 100. It will be appreciated that platform applications may themselves be SaaS applications, but are distinguished from other SaaS applications in the present disclosure as they are used to provide information about the customer that is used as a contextual basis for understanding SaaS application usage. In some implementations, a given platform application/service may be installed on-premise at the customer organization/entity. Examples of platform applications 122 include a single sign-on (SSO) service 124, a human resources (HR) management system 136, a finance application 128, an expense application 140, a contracts management application 132, and a networking service 144 (e.g. cloud access secure broker (CASB)).

In some implementations, the SSO service 124 exposes an API 126, and a corresponding one of the platform connectors for the SSO service 124 is configured to obtain data from the SSO service using the API 126. A list of SSO enabled applications can be obtained, as well as user login activity for each application, thereby providing broad visibility into the customer's SaaS application portfolio. By way of example without limitation, examples of SSO services include Okta™, Azure Active Directory™, Duo Security™, Idaptive™, OneLogin™ PingOne™, and Google Workspace™.

In some implementations, the HR management system 136 exposes an API 138, and a corresponding one of the platform connectors for the HR management system 136 is configured to obtain data from the HR management system 136 using the API 138. The customer's org chart data can be obtained from the HR management system 136, identifying the reporting structure and various organizational groups within the customer organization. Org chart data can be useful in enabling understanding of SaaS application usage and trends and distinguishing how they vary by team, location, and manager. Examples of HR management systems include Workday™, OneLogin™, Okta™, Azure Active Directory™, and Google Workspace™.

In some implementations, the finance application 128 exposes an API 130, and a corresponding one of the platform connectors for the finance application 128 is configured to obtain data from the finance application using the API 130. Payments data from the finance application 128 can be useful for discovering SaaS applications that are not otherwise known, and may not be managed by the customer's information technology (IT) department. Examples of finance application 128 include ERP systems such as Netsuite™ and Oracle™.

In some implementations, the expense application 140 exposes an API 142, and a corresponding one of the platform connectors for the expense application 140 is configured to obtain data from the expense application using the API 142. As with the payments data noted above, expense data from the expense application can also be useful for discovering SaaS applications that are not otherwise known, and may not be managed by the customer's information technology (IT) department. Examples of expense application 140 include Concur™ and Expensify™

In some implementations, the contracts management application 132 exposes an API 134, and a corresponding one of the platform connectors for the contracts management application 132 is configured to obtain data from the contracts management application using the API 134. Contracts data can be used to provide visibility into license levels and contract spend, enabling recommendations for rightsizing and renewing licenses, as well as reclaiming unused licenses. Examples of contract management applications include Coupa™ and Ironclad™.

In some implementations, the networking service 144 exposes an API 146, and a corresponding one of the platform connectors for the networking service 144 is configured to obtain data from the networking service using the API 146. In some implementations, the networking service 144 is defined by a cloud access secure broker (CASB) or other service/application that serves as a security enforcement point between the customer organization/entity and its SaaS applications or other cloud services. Data obtained from the networking service 144 provides another source for discovering applications through user logins and use over network activity.

It will be appreciated that the platform connectors 104 can be configured to automatically update data over time, for example, periodically pulling data from the relevant sources. In this manner, customer-specific contextual data for understanding SaaS application usage is continually maintained and tracks the current state of the customer organization. The data obtained from the customer's platform applications 122 is stored in the SMP 100 as platform data 108. While platform connectors 104 enable automatic retrieval of data directly from the customer's platform applications/services, it will be appreciated that, in the alternative, a given customer may upload their platform application data to the SMP 100.

The engagement connectors 106 are configured to obtain data pertaining to usage of the customer's SaaS application portfolio 148. For example, a given SaaS application 150 may expose an API 152, and a corresponding one of the engagement connectors 106 for the SaaS application 150 is configured to call the API 152 to obtain data describing events that occurred through customer usage of the SaaS application 150. Likewise, a given SaaS application 154 may expose an API 156, and a corresponding one of the engagement connectors 106 for the SaaS application 154 is configured to call the API 156 to obtain data describing events that occurred through customer usage of the SaaS application 154. It will be appreciated that there can be many SaaS applications in the customer's SaaS application portfolio 148, and each may expose an API that is called by a corresponding engagement connector to obtain data describing events occurring through usage of the applications. Such data is stored in the SMP 100 as SaaS app event data 110.

As described in further detail below, the SaaS app event data 110 is processed and analyzed to determine various aggregations and information describing the customer's usage of their SaaS application portfolio 148, which is stored as customer usage data 112. Such usage data can be accessed for viewing via a client device 114 operated by a user 118 (e.g. an employee of the customer organization viewing the usage data of the customer organization). By way of example without limitation, examples of client devices include personal computers, laptops, tablets, cellular phones, mobile devices, etc. In some implementations, the SMP 100 is accessed via a browser or application executed by the client device 114, and the customer usage data 112 is provided for viewing through the browser/application.

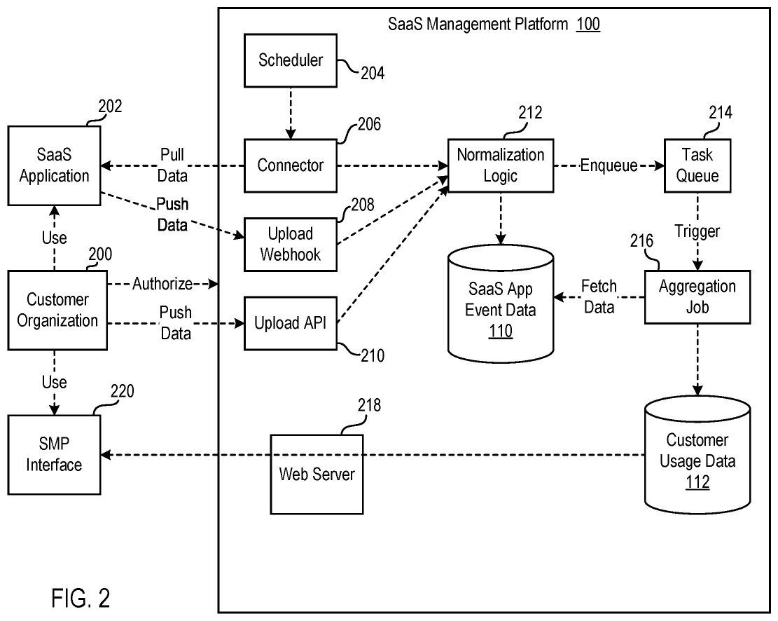

FIG. 2 conceptually illustrates aggregation of usage data in a SaaS management platform, in accordance with implementations of the disclosure.

In the illustrated implementation, a given customer organization 200 is a customer of the SMP 100. The customer organization 200 uses a SaaS application 202, and furthermore, authorizes the SMP 100 to be able to access the customer organization's data from the SaaS application 202. It will be appreciated that such authorization may occur through setup of an engagement connector 206 that is configured to access an exposed API of the SaaS application 202. The setup of the engagement connector 206 can include, for example, entry of login credentials for the SaaS application 202, and/or other verification procedures to confirm the customer organization's intent to enable the SMP 100 to access data stored by the SaaS application and relating to the customer organization's use of the SaaS application 202.

In some implementations, a scheduler 204 is configured to activate the connector 206 to pull data from the SaaS application 202. In some implementations, the scheduler 204 is configurable to trigger data pulls at periodic intervals and/or at predefined times (e.g. once per day at 2 am PST). In some implementations, the engagement connector 206 is configured to automatically pull data beginning immediately subsequent to the last time point of the previous data pull. In this way, duplication is avoided as data previously obtained from the SaaS application 202 will not be pulled again, but only new data that was stored subsequent to the time point of the last data that was pulled. In some implementations, data is pulled when a sufficient amount of new data has accumulated since the last data pull. For example, the connector 206 may poll the SaaS application 202 to determine whether a predefined amount of data has accumulated (e.g. predefined number of events/logins/activity, etc.), and if so, then initiate transfer of the data.

In some implementations, SaaS applications may push data to the SMP 100. For example, in some implementations, an upload webhook 208 is provided by the SMP, and the SaaS application 202 can be configured to access the upload webhook 208 to upload the customer organization's data to the SMP 100. It will be appreciated that the upload webhook 208 defines a URL (uniform resource locator) for an HTTP callback to initiate logic for receiving the customer organization's data from the SaaS application 202. In some implementations, the SaaS application 202 may be configured to automatically push data to the SMP 100 at periodic intervals and/or predefined times, or in response to predefined conditions (e.g. when a predefined amount of data has accumulated since the last time data was pushed to the SMP 100).

In some implementations, the customer organization 200 may choose to upload their data to the SMP 100 on their own. That is, the customer organization 200 may choose to obtain their data from the SaaS application 202, and then submit the data to the SMP 100, for example, via an upload API 210 exposed by the SMP 100. The customer organization 200 might not wish to authorize the SMP 100 to access their data from the SaaS application 202, and this provides a mechanism for the customer organization 200 to control the uploading of SaaS application-related data to the SMP 100.

Broadly speaking, the data obtained from the SaaS application 202 describes events that occurred as a result of usage of the SaaS application 202 by users associated with the customer organization (e.g. employees, contractors, etc.). The data is further processed by a normalization logic 212, which is configured to normalize the formatting and naming conventions of the raw event data from the SaaS application 202, so that such event data is stored in a consistent format and with event categories/names that are consistent across different SaaS applications. The normalized event data is stored as SaaS app event data 110. In some implementations, the normalization logic 212 is a feature of, or is included as part of, the connector 206; whereas in other implementations the normalization logic 212 is separate from the connector 206.

In some implementations, the normalization logic 212 is further configured to enqueue an aggregation task to a task queue 214. The task queue 214 triggers performance of queued aggregation tasks by an aggregation job 216. Broadly speaking, the aggregation job 216 is configured to aggregate events of a given SaaS app for a given customer organization, occurring during various time windows, and for various segments of users of the customer organization. The results of such aggregation tasks are stored as customer usage data 112, and used to determine customer-specific usage metrics which are served to a user of the customer organization 200 upon request. For example, the user may view usage data/metrics for their customer organization 200 through an SMP interface 220 rendered via the user's client device. In some implementations, the SMP interface 220 is a web interface (presented in a browser) accessing a web server 218 of the SMP 100 to obtain requested pieces of the customer usage data 112.

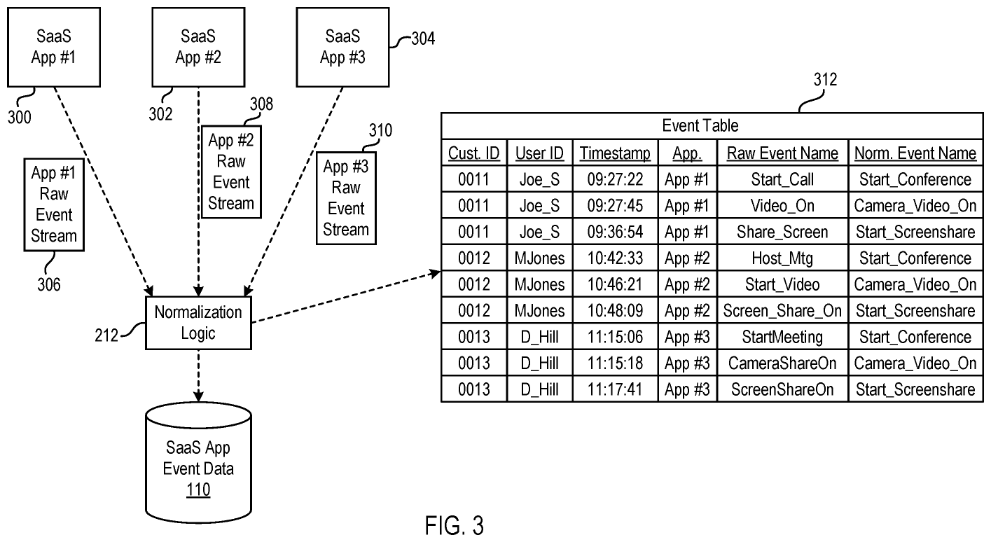

FIG. 3 conceptually illustrates normalization of event data across a plurality of SaaS applications for storage by a SaaS management platform, in accordance with implementations of the disclosure.

It will be appreciated that various SaaS applications may have substantially similar or the same functionality. A given type of SaaS application (e.g. video-conferencing, file-sharing, project management, etc.) is likely to have similar functionality to other applications of the same type. Hence, to facilitate analysis and understanding of usage across different applications of the same type, it is useful to normalize event data as has been described.

In the illustrated implementation, a scenario with multiple video-conferencing SaaS apps is considered for purposes of illustrating a normalization process in accordance with implementations of the disclosure. As shown, a first SaaS application 300, a second SaaS application 302, and a third SaaS application 304 are all video-conferencing SaaS applications. Data obtained from the first SaaS application 300 defines a raw event data stream 306; data obtained from the second SaaS application 302 defines a raw event data stream 308; and, data obtained from the third SaaS application 304 defines a raw event data stream 310. Generally, each raw event stream consists of data from the SaaS applications that describes events occurring through usage of the applications. Typically, data for each event includes an ID of the user that performed the event, a name/category of the event identifying what was performed, and a timestamp of the event.

It will be appreciated that the different SaaS applications 300, 302, and 304 include functionality that is substantially the same, yet is defined differently in their respective raw event data streams according to the conventions of each application. The normalization logic 212 is therefore configured to normalize the raw event data into common formatting, and with generic event naming/categorization, for storage as SaaS app event data 110 in the SMP 100. More specifically, the normalization logic 212 is configured to map the application-specific event names to generic/normalized event names, and the events are stored using the generic event names.

In some implementations, the normalization logic 212 generates an event table 312 that provides a mapping of the application specific event names to normalized generic event names. By way of example with reference to the illustrated implementation, each of the SaaS applications records an event when a user initiates a call. However, to describe such an event in their respective raw event data, the first SaaS application 300 uses the raw event name “Start_Call,” whereas the second SaaS application 302 uses the raw event name “Host_Mtg,” and the third SaaS application 304 uses the raw event name “StartMeeting.” To provide a common generic naming convention for such an event, in the eventtable 312, these raw event names are mapped to the same normalized event name “Start_Conference.”

As another example, each of the SaaS applications records an event when a user turns on video from their camera during a call. However, to describe such an event in their respective raw event data, the first SaaS application 300 uses the raw event name “Video_On,” whereas the second SaaS application 302 uses the raw event name “Start_Video,” and the third SaaS application 304 uses the raw event name “CameraShareOn.” To provide a common generic naming convention for such an event, in the event table 312, these raw event names are mapped to the same normalized event name “Camera_Video_On.”

As another example, each of the SaaS applications records an event when a user initiates sharing of their screen during a call. However, to describe such an event in their respective raw event data, the first SaaS application 300 uses the raw event name “Share_Screen,” whereas the second SaaS application 302 uses the raw event name “Screen_Share_On,” and the third SaaS application 304 uses the raw event name “ScreenShareOn.” To provide a common generic naming convention for such an event, in the event table 312, these raw event names are mapped to the same normalized event name “Start_Screenshare.”

Thus, for raw event data obtained from the SaaS applications 300, 302, and 304, their respective raw event names are mapped to the normalized event names as shown in event table 312, and the event data is stored as SaaS app event data 110 using the normalized event names. By using normalized event names such as those described above, it becomes possible to more directly understand usage of common features across different SaaS applications. This can be used, for example, to determine industry usage of a given feature across a set of SaaS applications with similar functionality.

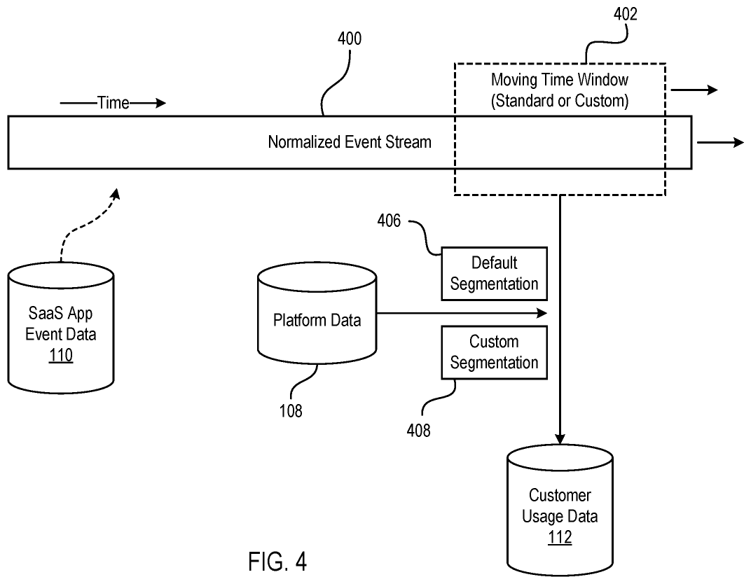

FIG. 4 conceptually illustrates aggregation of event data using rolling windows to determine app usage information for a given customer organization, in accordance with implementations of the disclosure.

Broadly speaking, as described above, the SMP 100 includes an aggregation job 216 configured to determine various aggregations and metrics of engagement with SaaS applications, which are stored as customer usage data 112. With continued reference to FIG. 4, a process for performing such aggregation is conceptually shown. The SaaS app event data 110 defines a normalized event stream 400 for a given SaaS application in the customer organization's portfolio. The normalized event stream 400 consists of normalized event data which describes engagement events with the SaaS application by users within the customer organization. It will be appreciated that a singular SaaS application is considered herein, and that similar processes can be applied to other SaaS applications in the customer organization's portfolio.

A rolling time window 402 is implemented to define time periods for which to aggregate event data and determine engagement metrics. That is, a given amount of time (e.g. several hours, a day, several days, one or more weeks, 30 days, one or more months, etc.) is defined, and aggregate event data and engagement metrics are determined for the given amount of time at consecutive periodic intervals. For example, aggregate event data and engagement metrics may be determined each day for the preceding 7-day and 30-day period. Thus, a 7-day and a 30-day rolling window are defined, with aggregations and engagement metrics determined on a daily basis for each. As another example of a rolling time window, aggregate event data and engagement metrics may be determined each week for the preceding 60 days, thereby defining an approximate two-month rolling time window that is implemented at one-week intervals.

In some implementations, the SMP 100 may provide certain standard rolling time windows. In some implementations, the platform can support custom rolling time windows, enabling customers to define their own preferred rolling time windows, including custom-defined time periods, and custom-defined periodic intervals for aggregation.

It will be appreciated that the implementation of rolling time windows provides for a rich set of engagement data to be determined. For as opposed to fixed windows (e.g. aggregation for each calendar month), the rolling time windows enable tracking of engagement trends with high levels of granularity (e.g. can understand trend in 30-day usage on a daily basis).

In some implementations, the aggregation process entails building a table listing each user and what actions they have performed in a given SaaS application during a given time window. Such a table can be stored and used to determine the customer's aggregate use of a given feature for the given time window.

It will be appreciated that engagement/usage activity of the SaaS application of interest is understood from the event data. Examples of events indicating engagement/usage activity include user logins, usage/activation/initiation of one or more features of the SaaS application, or other ways that users may engage with the SaaS application that have been recorded in the application's event data or which can be determined from the recorded event data.

To determine a customer-wide aggregation or engagement metric for a given feature, then typically, data across all provisioned/licensed users (of the customer organization) of the given SaaS application within the given time window is considered. In some implementations, an aggregation is determined, for example, by determining an aggregate number of users that performed the specified engagement/usage activity within the time window (or an aggregate number of times such was performed, or an aggregate amount of time such was performed). Metrics of the specified engagement/usage activity for the given time window can be determined from the event data, or derived from a given aggregation. Examples of metrics include a fraction or percentage of users (out of the provisioned users of the customer organization) that performed the activity during the time window, an average/median number of times users performed the activity during the time window, an average/median amount of time spent by users engaging in the activity, etc.

It will be appreciated that if the SaaS application has multiple license tiers, then aggregations and/or metrics can be determined for each license tier. This can be useful in providing visibility into SaaS application usage as it relates to different licensing tiers, and understanding whether the customer organization's users are using more costly features at higher licensing tiers.

Additionally, aggregations and/or metrics can be determined for particular segments/groups of users within the customer organization. For example, such aggregations/metrics can be determined for a specific team/group, users that are part of a given managerial group, users at a particular location/office, combinations thereof, etc. In some implementations, the segments of users are determined by accessing the customer's org chart data or other contextual data of the customer organization, which may be obtained from the platform data 108. In some implementations, usage aggregations/metrics for certain segments of users are determined by the SMP 100 by default. That is, a default segmentation 406 is applied to the time window 402 to determine aggregations/metrics for certain standard groups of users. In some implementations, custom segments of users can be defined for which usage aggregations/metrics will be determined. That is, a custom segmentation 408 is applied to the time window 402 to determine aggregations/metrics for certain custom-defined groups of users. In some implementations, the default segmentation 406 or custom segmentation 408 defines a filter applied to event data falling within the time window 402, thereby yielding event data of a particular segment of users that is processed into aggregations/metrics and stored as customer usage data 112.

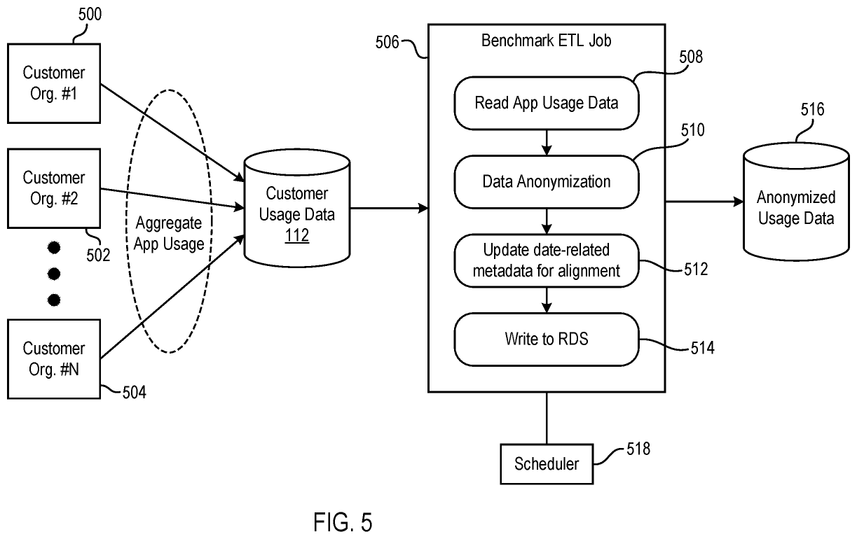

FIG. 5 conceptually illustrates determination of SaaS application engagement/usage benchmarks in a SaaS management platform, in accordance with implementations of the disclosure.

Broadly speaking, benchmarks are metrics indicating how a cohort of customers of the SMP 100 engages with or uses SaaS applications. Benchmarks enable an individual customer organization to understand how their engagement/usage of a given SaaS application compares against other customer organizations that also use the given SaaS application.

With continued reference to FIG. 5, initially, for each customer organization of the SMP 100, such as customer organizations 500, 502, 504, etc., aggregations/metrics of their usage of their respective SaaS applications is determined, and stored as customer usage data 112. Thus, aggregations/metrics for each customer describing engagement/usage of each SaaS application are stored by the SMP 100.

A benchmark ETL (extraction, transform, load) job/process 506 is implemented by the SMP 100 as a background process for converting usage data into a form enabling efficient benchmark generation. Broadly speaking, the benchmark ETL job 506 is configured to process usage data pertaining to each SaaS application and store anonymized usage data 516 that will be used to surface specific benchmarks to requesting users through the SMP's interface. In some implementations, the benchmark ETL job performs various process steps as detailed below.

At process step 508, SaaS application-specific usage data is read from the customer usage data 112. That is, for a given SaaS application, usage data across the various customers of the SMP 100 that use that SaaS application are obtained. By way of example without limitation, usage data for the given SaaS application can include a listing of customer organizations and their previously determined usage aggregations/metrics for the SaaS application. Additionally, contextual data about each customer organization can be included, such as size, location, industry (e.g. technology, media, life-sciences, energy, finance, transportation, etc.), number of licenses (for each tier, if applicable), number of SaaS applications in portfolio, etc.

At process step 510, the application usage data is anonymized by removing the names of individual customer organizations. It will be appreciated that individual user names are already removed in the usage aggregations/metrics, as the usage aggregations/metrics are based on aggregates of individual user event data. And by removing customer organization names, the data used for benchmarking is further anonymized. In some implementations, each customer organization is assigned a unique identifier (e.g. a number) in place of the customer organization's name. Further, in some implementations, certain characteristics of the customer organizations, such as any of the above described contextual data about each customer organization, are retained in the data for later use in determining appropriate cohorts of customers for benchmarking.

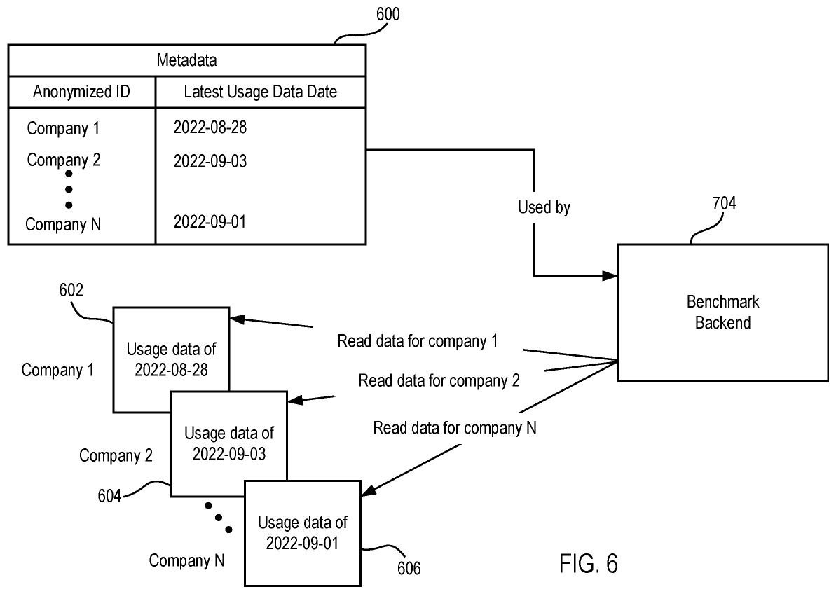

At process step 512, date-related metadata are updated for purposes of alignment to enable consideration of data from time windows of equivalent duration but which may have different start/end dates. (In some implementations, dates can include specified days as well as more specific times, such as hours, minutes, and seconds.) This enables inclusion of different customers' data for whom the dates of their latest usage data differ from one another. For example, this can include customers that stopped using the SaaS application or stopped using the SMP 100 at some point in the past. This concept is discussed in further detail below with reference to FIG. 6.

With continued reference to FIG. 5, then at process step 514, the resulting anonymized usage data 516 is stored, e.g. to a relational database. It will be appreciated that the anonymized usage data 516 is grouped by application.

A scheduler 518 is configured to run the benchmark ETL job 506 at predefined times and/or periodic intervals. For example, in some implementations, the scheduler 518 is configured to run the benchmark ETL job once a day, once every two days, once every 12 hours, once a week, etc.

FIG. 6 conceptually illustrates configuration of date-related metadata as part of a benchmarking process, in accordance with implementations of the disclosure.

As noted above, date-related metadata are processed as part of the benchmark ETL job's process. To accomplish this, as shown in the illustrated implementation, the benchmark ETL job 506 accesses date-related metadata 600, which is conceptualized as a table correlating the anonymized ID of each customer organization (company 1, 2, . . . , N) to the customer organization's latest usage data date. The benchmark ETL job 506 updates the latest usage data date in the metadata 600 to the current date for any anonymized customer having new usage data for the given SaaS application that was processed into the anonymized usage data. Hence, the latest usage data date provides the most recent date for which usage data (aggregations/metrics) was aggregated or determined for a given time window duration (and SaaS application) of interest.

It will be appreciated that different customer organizations may have different latest usage data dates for various reasons. For example, some customer organizations may have stopped using the SMP 100 at some point in the past, while other customer organizations continue to use the SMP 100 currently. Some customer organizations may have stopped using the SaaS application at some point in the past, while other customer organizations continue to use the SaaS application currently. The event data for certain customer organizations may be obtained at times that do not align with those of other customer organizations, and usage data may be determined at different times as a result.

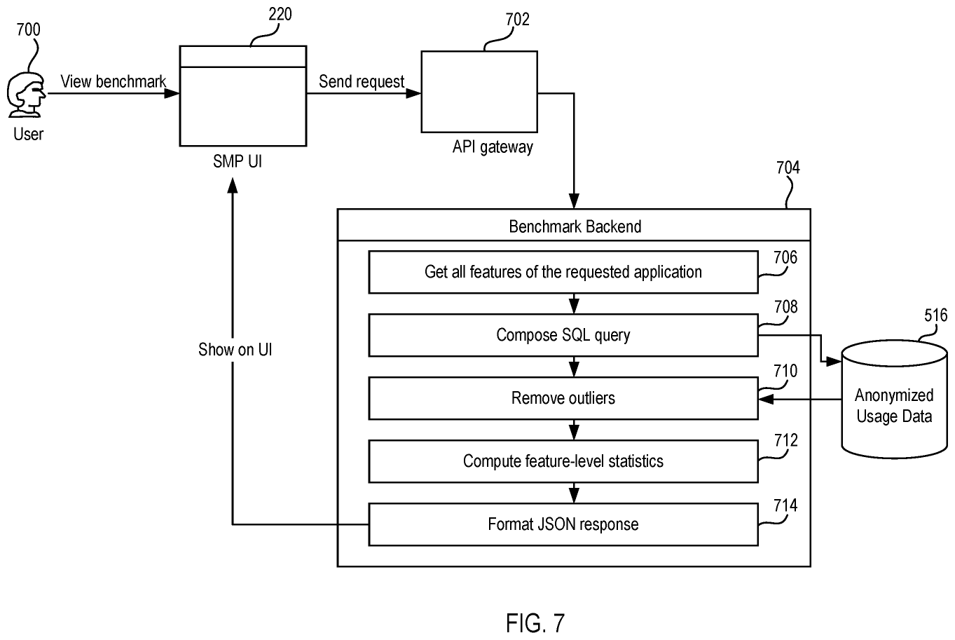

However, though not all customer organizations may have usage data extending to the current date or the same date, the usage data of a customer with a latest usage data date in the past is still useful to consider for purposes of benchmarking. Thus, to enable this, the latest usage data date for each customer organization is obtained from the metadata 600. More specifically, the metadata 600 is used by a benchmark backend 704 (described below with reference to FIG. 7) to facilitate obtaining usage data from different anonymized customers that may be from different dates, but which are nonetheless relevant for determining a given benchmark.

For example, a company 1 may have a latest usage data date of 2022-08-28, and therefore for company 1, usage data 602 of 2022-08-28 is read for purposes of generating a benchmark. Whereas, a company 2 may have a latest usage data date of 2022-09-03, and therefore for company 2, usage data 604 of 2022-09-03 is read for purposes of generating the benchmark. And a company N may have a latest usage data date of 2022-09-01, and therefore for company 3, usage data 606 of 2022-09-01 is read for purposes of generating the benchmark. It will be appreciated that the usage data 602, 604, and 606 are each for the same duration time window, but starting and ending at different dates. In this manner, the latest usage data for each customer is obtained, even though such data may be from different date ranges.

Furthermore, it will be appreciated that beyond a certain point, some usage data may be considered too stale or too old for inclusion in the benchmarking process. Therefore, in some implementations, if the latest usage data date is earlier than the current date by more than a predefined amount (e.g. 6 months, 9 months, one year, etc.), then the usage data of that customer organization is disregarded for purposes of benchmarking the particular SaaS application of interest. In this manner, current usage data is considered for benchmarking purposes, and usage data that is older than a specified amount is disregarded. It will be appreciated that a given customer organization may have usage data that is too old for use in benchmarking for one SaaS application, while possessing usage data that is current enough for use in benchmarking a different SaaS application.

FIG. 7 conceptually illustrates servicing of a request to view a benchmark in a user interface of a SaaS management platform, in accordance with implementations of the disclosure.

In the illustrated implementation, a user 700 (e.g. employee or other person associated with a customer of the SMP 100) interacts with the user interface 220 of the SMP 100. The user 700 initiates, through the user interface 220, a request to view one or more benchmarks for a SaaS application. The request is sent to an API gateway 702 of the SMP 100, triggering a benchmark backend logic 704 to perform a process to service the request. At process step 706, the incoming request is received to obtain all the features of the requested SaaS application.

At process step 708 a query (e.g. database query such as a SQL query) is composed to retrieve the relevant data from the anonymized usage data 516. That is, the query is configured to retrieve the anonymized usage data that pertains to the specified SaaS application. In some implementations, this includes usage data of each anonymized customer organization that had usage data stored for the requested SaaS application.

In some implementations, the query is configured to retrieve usage data from a cohort of customers having characteristics similar to that of the requesting user's customer organization. That is, the query is configured to retrieve usage data of the requested SaaS application, from the anonymized usage data 516, such that the usage data is from anonymized customers having specified characteristics which define the cohort (e.g. size, industry, number of licenses, number of SaaS applications in portfolio, geographic location, etc.).

At process step 710, outliers are removed or discarded from the retrieved usage data. In some implementations, this can entail removing usage data that is from customers having fewer than a predefined number of licenses (e.g. less than 50, less than 10, etc.). In some implementations, removing outliers is performed by removing usage data indicating usage/engagement by a customer organization that is extremely low or extremely high relative to their number of provisioned users/licenses, and/or relative to the other customer organizations (e.g. greater than two standard deviations from a mean/average of usage/engagement, greater than a predefined amount outside of an interquartile range, etc.), and/or relative to other usage/engagement indicators.

In some implementations, usage of a given feature of the SaaS application might be expected to be correlated to usage of another feature. And therefore, if the usage of both features is not sufficiently correlated (e.g. sufficiently similar usage amount) in the usage data of a given anonymized customer, then that customer's usage data is discarded. On the other hand, in some implementations, usage of a given feature of the SaaS application might be expected to be inversely correlated to usage of another feature. And therefore, if the usage of both features is not sufficiently dissimilar (e.g. usage amounts are not sufficiently dissimilar) in the usage data of a given anonymized customer, then that customer's usage data is discarded. While two features are considered in the foregoing discussion, it will be appreciated that in other embodiments, the concepts can be extended to more than two features of the SaaS application, such that correlation and/or inverse correlation of usage amongst two or more features of the SaaS application are evaluated by the system to determine the existence of outliers.

In some implementations, the profile of the customer organization can be expected to indicate a certain pattern of usage of features of the SaaS application. That is, one or more of the characteristics of a given anonymized customer organization may predict its usage of features of the SaaS application. In some implementations, one or more characteristics of the customer organization is used to determine an expected pattern of usage (e.g. expected range of usage/engagement with one or more features), and if the usage data for the customer does not it its expected pattern of usage, then the customer's usage data is discarded as an outlier.

In some implementations, a machine learning (ML) model is trained to recognize outliers in the usage data, based on any of the presently described factors, including characteristics of the anonymized customer organization, and characteristics of the usage data. Such a trained ML model can be used to identify outliers, which are discarded from the retrieved usage data.

At process step 712, following removal of outliers from the retrieved usage data, then application usage and feature-level benchmark statistics are computed for the SaaS application of interest. Broadly speaking, these benchmarks identify how customers of the SMP 100 are using or engaging with the SaaS application. As noted, the customers included can be a cohort of customers of which the requesting user's customer organization is a member (i.e. customers with similar characteristics to the requesting user's customer organization).

It will be appreciated that various types of benchmarks are possible for a given SaaS application. For example, in some implementations, a usage benchmark for the SaaS application can identify, for a cohort of anonymized customer organizations, what fraction or percentage of provisioned/licensed users have used the application within the specified time window (e.g. latest 30-day period or other time window). In some implementations, a usage benchmark defines, across the customer organizations of the cohort, an average or median fraction/percentage of provisioned/licensed users that used the application within the specified time window. It will be appreciated that usage may be determined based on login activity and/or activation of one or more features of the application. Furthermore, usage benchmarks may be segmented by license tier if applicable, enabling visibility into how application usage may differ for different license tiers of the SaaS application.

Various types of feature-level benchmarks are possible. In some implementations, a feature benchmark for the SaaS application can identify, for a cohort of anonymized customer organizations, what fraction or percentage of provisioned/licensed users have used a given feature of the application within the specified time window (e.g. latest 30-day period or other time window). In some implementations, a feature benchmark defines a median or average of customer use of a given feature during the time window. That is, usage of the feature by each customer organization of the cohort is determined, and the median or average is determined as the feature benchmark. In some implementations, customer usage of the feature is determined as the fraction or percentage of provisioned/licensed users (of a given customer organization) that used the feature within the specified time window. In some implementations, customer usage of the feature is determined as an average or median number of times that a provisioned/licensed user used a feature within the specified time window (or a frequency of use). In some implementations, customer usage of the feature is determined as an average or median amount of time that a provisioned/licensed user used a feature within the specified time window.

Furthermore, it will be appreciated that feature benchmarks may be segmented by license tier if applicable, enabling visibility into how feature usage may differ for different license tiers of the SaaS application.

At process step 714, a response to the original request including the relevant benchmarks is prepared and returned for rendering in the user interface 220 to be viewed by the user 700. In some implementations, this entails formatting the response in a suitable file/data format, such as JSON, XML, CSV, etc.

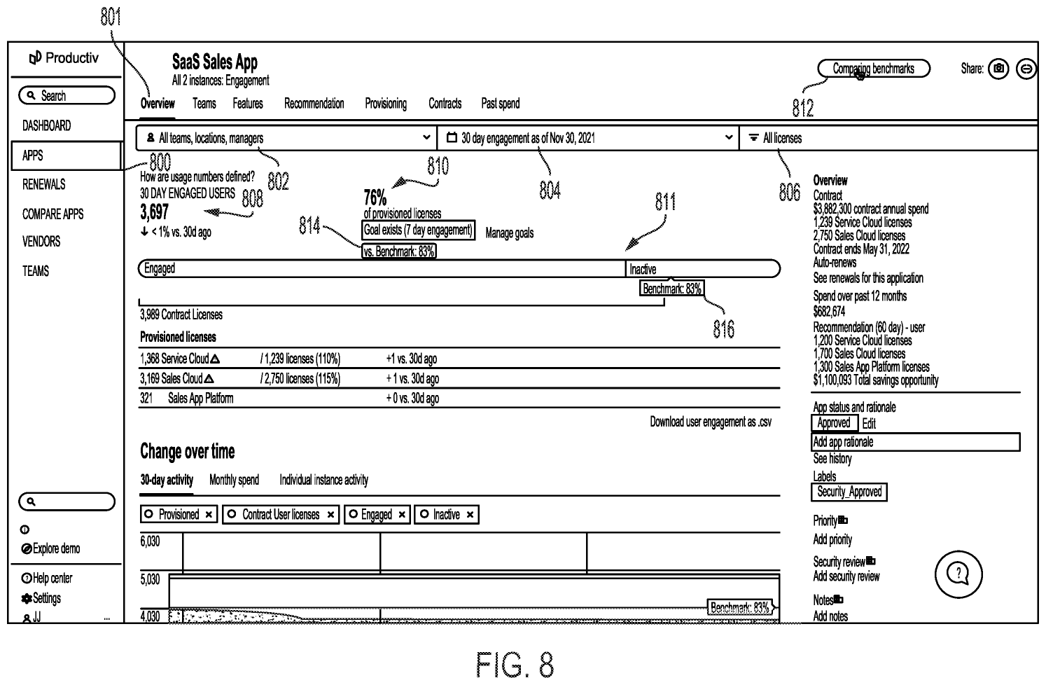

FIG. 8 illustrates an example of a user interface for accessing customer usage data for a SaaS application, and related benchmarks, in accordance with implementations of the disclosure.

The illustrated user interface is configured to access an SMP as has been described, enabling a customer of the SMP to view their SaaS application related information as stored and presented by the SMP. In the illustrated view, from the menu shown on the left side, the “APPS” button 800 is highlighted, indicating current viewing of an apps section of the user interface as shown. More specifically, a view of the customer's usage data for the “SaaS Sales App” application is shown.

An “Overview” 801 is currently selected, thereby causing display of an overview of the customer's usage of the application. More specifically, overall user engagement with the application is shown.

A segment selector 802 is configured to enable selection of a segment of personnel of the customer (e.g. team, location, managerial group, etc.), for which to display engagement information. As shown, the segment selector 802 indicates that all personnel (all teams, locations, and managers) are currently selected.

A time window selector 804 enables selection of a given time window for which to display engagement information. In the illustrated implementation, 30-day window ending on Nov. 30, 2021, is currently selected.

A license tier selector 806 enables selection of a given license tier for the application. As shown in the illustrated implementation, currently “All licenses” are selected, thus including all license tiers in the engagement data shown.

Thus, in view of the above, the customer's 30-day engagement across all personnel, and all license tiers is shown. At reference 808, the number of users that have engaged with the application within the specified 30-day time window is displayed. At reference 810, this is expressed as a percentage of the provisioned licenses for the application. This is further graphically shown by the bar indicator 811, illustrating engaged versus inactive users.

A benchmark button 812 is selectable to enable viewing of benchmarks in the current view, and has been selected as shown. Thus, a benchmark amount 814 is shown, indicating that for a median customer in the customer's cohort, 83% of provisioned users are engaged with the application over the same 30-day time window.

A benchmark indicator 816 is also shown, graphically indicating the benchmark relative to the bar indicator 811, thus providing a graphical representation of the benchmark as compared to the customer's engaged versus inactive users.

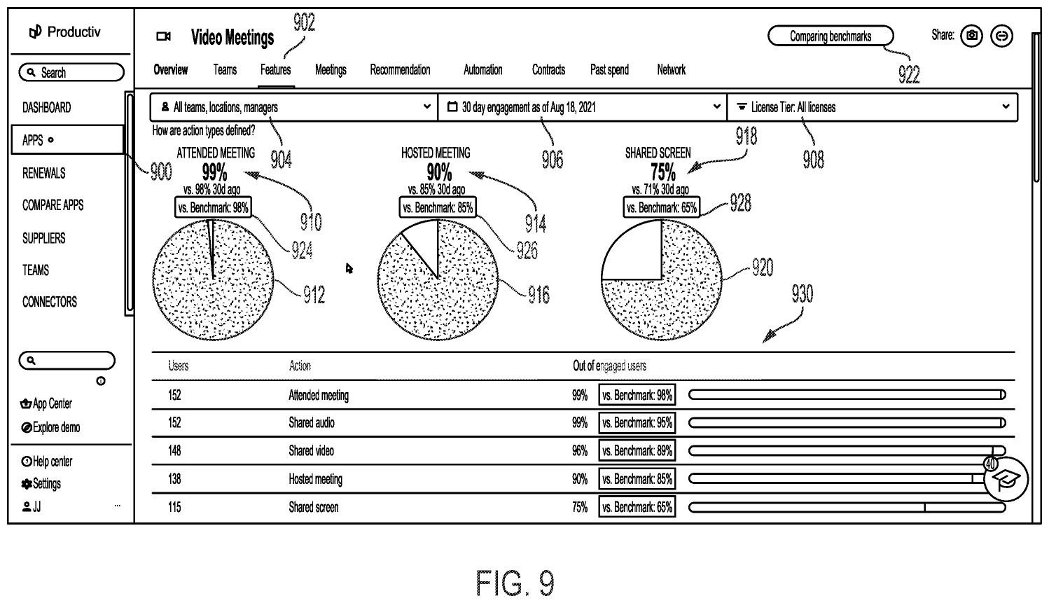

FIG. 9 illustrates an example of a user interface displaying feature-level benchmarks for a SaaS application, in accordance with implementations of the disclosure.

The illustrated user interface is configured to access an SMP and display a customer's information as has been described. An “APPS” 900 section is displayed in the current view, and more specifically, a view of the customer's feature usage of the “Video Meetings” application is shown. A “Features” 902 tab is currently selected to enable viewing of the customer's feature-level engagement data for the application.

In the illustrated implementation, the segment selector 904 is configured to enable selection of a segment of the customer's users, and is currently set to all teams, locations, and managerial groups. In the illustrated implementation, the time window selector 906 is configured to enable selection of a time window over which to present feature engagement information, and is currently set to a 30-day time window ending on Aug. 18, 2021. A license tier selector 908 is configured to enable selection of license tiers of the application for viewing, and is currently set to view all license tiers.

As shown, engagement metrics for various features of the application are shown. For example, at reference 910, a percentage of licensed users that attended a meeting during the time window is shown (99% in the illustrated implementation), and this percentage is graphically represented in the form of a pie chart 912. At reference 914, a percentage of licensed users that hosted a meeting during the time window is shown (90% in the illustrated implementation), and this percentage is graphically represented in the form of a pie chart 916. At reference 918, a percentage of licensed users that shared their screen during the time window is shown (75% in the illustrated implementation), and this percentage is graphically represented in the form of a pie chart 920.

A benchmark button 922 is currently selected, enabling viewing of corresponding benchmarks for the various feature engagement metrics of the application. Thus, in the illustrated implementation, regarding the feature of attending a meeting, a benchmark display 924 shows a benchmark of 98%, indicating that for a median customer of the customer's cohort, 98% of licensed users attended a meeting during the same time window. Regarding the feature of hosting a meeting, a benchmark display 926 shows a benchmark of 85%, indicating that for a median customer of the customer's cohort, 85% of licensed users hosted a meeting during the same time window. Regarding the feature of sharing their screen, a benchmark display 928 shows a benchmark of 65%, indicating that for a median customer of the customer's cohort, 65% of licensed users shared their screen during the same time window.

At reference 930, a listing of various features of the application is shown, including the number of users that performed a given action within the time window, the name of the action, the percentage that the number of users represents out of the users that engaged with the application during the time window, and the corresponding benchmark percentage.

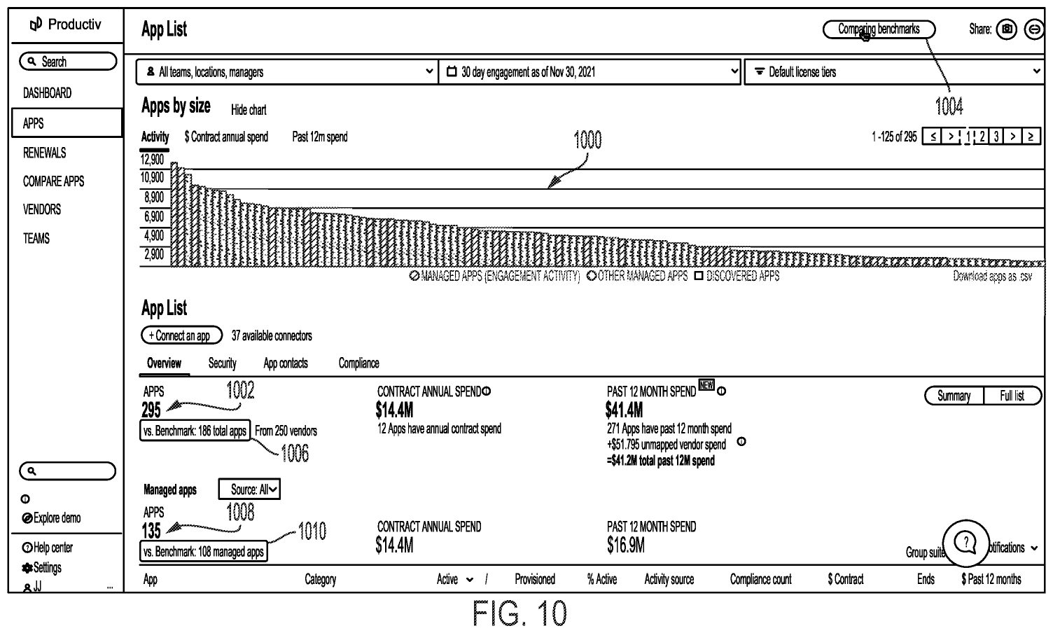

FIG. 10 illustrates a user interface showing a portfolio of applications for a customer of a SMP, in accordance with implementations of the disclosure.

In some implementations, portfolio-level benchmarks are provided for a customer's portfolio of applications. For example, in some implementations, a benchmark is provided for the number of applications that a given customer uses. That is, a benchmark number of applications can be determined for a cohort of customers of the SMP. In some implementations, this is defined as the median or average number of applications that a customer in the cohort uses (or subscribes to). The number of applications can be further broken down into the number of managed apps and unmanaged or discovered apps, and corresponding benchmarks can be determined for these numbers as well.

To determine a given customer's cohort, various factors can be considered such as the customer's size, location, industry, etc. as has previously been described.

With continued reference to FIG. 10, in the illustrated implementation, a view showing a summary of a customer's applications is provided. For example, a bar graph 1000 is configured to graphically depict contract annual spend over the past 12 months per application, with managed and unmanaged apps distinguishable in the bar graph.

At reference 1002, the total number of applications subscribed to by the customer is shown. A benchmark button 1004 has been selected, activating viewing of benchmarks in the interface view. Therefore, a corresponding benchmark display 1006 is provided, showing the benchmark number of applications typically used by a customer in the same cohort.

Additionally, at reference 1008, the number of managed applications is shown for the customer. And a corresponding benchmark display 110 shows the benchmark number of managed applications for a customer in the same cohort.

It will be appreciated that the above described componentry of the SMP 100 can be configured to provide portfolio-level benchmarks in accordance with implementations of the disclosure. For example, in some implementations, the benchmark ETL job 506 is configured to obtain the number of managed and unmanaged applications for each customer, along with certain customer characteristics, and anonymize such information. The resulting anonymized portfolio data can be accessed by the benchmark backend 704 to service requests for portfolio-level benchmarks in accordance with processed described above, including determination of a given customer's cohort from which to determine benchmarks, and filtering of outliers in the anonymized portfolio data.

In one configuration, the SMP includes compute and storage resources for management of SaaS applications. As described above, a web user interface (UI) can be provided to enable remote client devices to use and access services of the SMP. In some implementations, at least some code integrated with the UI is configured to make API calls to the SMP to access data, compute, and storage resources. In one embodiment, the compute and storage resources which run the SMP are run in a cloud-based environment. The cloud-based environment, for example, may be provided by a cloud compute and storage servicing entity, e.g., such as Amazon Web Services (AWS)™, Google™ Cloud, Microsoft™ Azure™, or other serving entities. In some configurations, hybrid cloud systems may be used, wherein some processes are executed by a cloud compute and storage servicing entity and other processes are serviced by private servers and storage or a private cloud. In still other embodiments, the processing can be executed entirely on private services and storage or private cloud configuration. In some embodiments, the servicing entities are referred to as hosting services, which provide the hardware and internet connectivity to execute applications, processes, and workflows using various types of hardware configurations.

In some configurations, data that is retrieved from the various SaaS entities using APIs or other accessing code can be stored in one or more databases that make access and further processing more efficient. By way of example, a relational database may be executed for storing data, retrieval of data, and manipulation (e.g., processing) of data. In one embodiment, the database may use a structured query language (SQL) as the programming language that is used to manage relational database data and perform various operations on the data in them. Without limitation, sometimes databases may be referred to as relational database management systems (RDBMS), relational data stream management systems (RDSMS), or simply a database. Generally, relational databases are particularly useful in handling structured data, i.e., data incorporating relations among entities and variables, such as data obtained and processed by an SMP. It should be understood that other database standards or protocols can be used, so long as the processing of SaaS data can be performed for rendering benchmarking and analytics and/or presentation tasks.

In some configurations, the hardware configurations may include virtualized hardware and expandable storage to meet the processing needs of the SMP. Broadly speaking, the SMP is executed using cloud infrastructure, which includes the use of one or more multiple interconnected data centers throughout the world. Based on the load demands for servicing the SMP, the resources may be expanded.

It should be apparent that the present embodiments may be practiced without some or all of these specific details. Modification to the modules, code and communication interfaces are also possible, so long as the defined functionality for the SMP or modules of the SMP is maintained. In other instances, well-known process operations have not been described in detail in order not to unnecessarily obscure the present embodiments.

One or more embodiments can also be fabricated as computer-readable code on a non-transitory computer-readable storage medium. The non-transitory computer-readable storage medium is any non-transitory data storage device that can store data, which can thereafter be read by a computer system. Examples of the non-transitory computer-readable storage medium include solid state drives (SSDs), hard drives, network attached storage (NAS), read-only memory, random-access memory, persistent memory, CD-ROMs, CD-Rs, CD-RWs, magnetic tapes and other optical and non-optical data storage devices. The non-transitory computer-readable storage medium can include computer-readable storage medium distributed over a network-coupled computer system so that the computer-readable code is stored and executed in a distributed fashion.

Although the method operations were described in a specific order, it should be understood that other housekeeping operations may be performed in between operations, or operations may be adjusted so that they occur at slightly different times, or may be distributed in a system that allows the occurrence of the processing operations at various intervals associated with the processing, as long as the processing of the overlay operations are performed in the desired way.

While the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the described embodiments and sample appended claims.

What is claimed is:

1. A software as a service (SaaS) management platform (SMP) implemented in a cloud resource having at least one server computer and at least one storage device, the SMP being accessible over the Internet by a plurality of customers that subscribe to the SMP, the SMP comprising:
a plurality of connectors configured to access customer data from a respective plurality of SaaS applications, wherein for each customer of the SMP, said connectors are used to obtain customer event data for each SaaS application to which the customer is subscribed by accessing over the Internet an API of each SaaS application to which the customer is subscribed;
wherein said connectors include a human resources (HR) connector that accesses, over the Internet, an API of an HR SaaS application to obtain org chart data for a given customer, wherein the SMP uses the org chart data to automatically define a plurality of personnel segments of the given customer;
an aggregation job that, for each customer of the SMP, periodically aggregates the event data for each SaaS application over a moving time window to generate customer usage data indicating customer use of features of each SaaS application;
a benchmark background job that, for each of the plurality of SaaS applications, obtains and anonymizes the customer usage data for the SaaS application across the plurality of customers of the SMP to generate anonymized usage data that is grouped by SaaS application;
a benchmark backend that, responsive to a request received over the Internet from a client device, reads the anonymized usage data for a given SaaS application, defines a cohort of anonymized customers in the anonymized usage data, generates one or more benchmarks defining median use of one or more respective features of the given SaaS application by the anonymized customers of the cohort, and returns the benchmarks to the client device responsive to the request in substantial real-time, wherein defining the cohort of anonymized customers includes selecting anonymized customers from the anonymized usage data such that the selected anonymized customers have greater than a predefined minimum number of licenses for the SaaS application;
a web server that provides over the Internet a graphical user interface rendered by the client device that is associated to a user of a given customer, the graphical user interface includes a graphical segment control element providing access to said personnel segments of the given customer and enabling selection of a given personnel segment, the graphical user interface includes a benchmark button, wherein the request being generated responsive to selection of said benchmark button of the graphical user interface rendered by the client device, and wherein responsive to the selection of the benchmark button and the selection of the given personnel segment via the graphical segment control element then said graphical user interface is configured to change a display of the customer usage data in the graphical user interface to display the customer usage data of the given personnel segment of the given customer and the benchmarks for the features of the SaaS application;
wherein the use of a given feature is defined by a number of times licensed users of a customer used the feature during the moving time window, such that the benchmark for the given feature identifies a median number of times licensed users, for an anonymized customer of the cohort, used the feature during the moving time window.

2. The SMP of claim 1, wherein the use of a given feature is defined by a fraction or percentage of licensed users of a customer that used the feature during the moving time window, such that the benchmark for the given feature identifies a median fraction or percentage of licensed users, for an anonymized customer of the cohort, that used the feature during the moving time window.

3. (canceled)

4. The SMP of claim 1, wherein the moving time window is configured so that each successive aggregation performed by the aggregation job aggregates event data over an equivalent and overlapping duration of time to that of a preceding aggregation performed by the aggregation job.

5. The SMP of claim 1, wherein the moving time window is defined by a predefined number of days preceding a current date.

6. (canceled)

7. (canceled)

8. The SMP of claim 1, wherein generating the one or more benchmarks includes filtering outliers from the anonymized usage data of the cohort.

9. The SMP of claim 1, wherein at least one of the plurality of connectors is configured to access an API of a respective SaaS application.

10. The SMP of claim 1, wherein anonymizing the obtained customer usage data includes removing customer names from the customer usage data, assigning each customer a unique identifier, and retaining characteristics of each customer in the customer usage data.

11. A software as a service (SaaS) management platform (SMP) implemented on one or more server computers, comprising:
a connector that, for each of a plurality of customer organizations of the SMP, obtains, over a network from an API of a SaaS application, event data identifying events that occurred through use of the SaaS application;
a human resources (HR) connector that accesses, over the network, an API of an HR SaaS application to obtain org chart data for a given customer organization, wherein the SMP uses the org chart data to automatically define a plurality of personnel segments of the given customer organization;
an aggregation job that periodically aggregates the event data for each of the customer organizations occurring during a rolling time window, to generate customer usage data for each customer organization, the customer usage data indicating usage amounts of features of the SaaS application by each customer organization during said rolling time window;
a benchmark background job that obtains the customer usage data for each of the customer organizations, and anonymizes said obtained customer usage data, and stores the anonymized usage data in association with the SaaS application;
a benchmark backend that receives, over the network, a request for feature benchmarks from a client device accessing the SMP over the network, and responsive to the request, retrieves the anonymized usage data, identifies a cohort of anonymized customer organizations from the anonymized usage data, determines the feature benchmarks which identify usage of the features of the SaaS application by the cohort of anonymized customer organizations based on a corresponding subset of the anonymized usage data, and responsive to the request transmits the feature benchmarks over the network to the client device in substantial real-time, wherein identifying the cohort of anonymized customer organizations is defined by selecting anonymized customer organizations having greater than a predefined minimum number of licenses for the SaaS application;
a web server that provides over the Internet a graphical user interface rendered by the client device that is associated to a user of a given customer organization, the graphical user interface includes a graphical segment control element providing access to said personnel segments of the given customer organization and enabling selection of a given personnel segment, the graphical user interface includes a benchmark button, wherein the request being generated responsive to selection of said benchmark button of the graphical user interface rendered by the client device, and wherein responsive to the selection of the benchmark button and the selection of the given personnel segment via the graphical segment control element then said graphical user interface is configured to change a display of the customer usage data in the graphical user interface to display the customer usage data of the given personnel segment of the given customer organization and the benchmarks for the features of the SaaS application.

12. The SMP of claim 11, wherein the feature benchmarks identify a median or average use of each of the features of the SaaS application during the rolling time window, wherein the use of a given feature is defined by a fraction or percentage of licensed users of a customer organization that used the feature during the rolling time window, such that the feature benchmark for the given feature identifies a median or average fraction or percentage of licensed users, for an anonymized customer organization of the cohort, that used the feature during the rolling time window.

13. The SMP of claim 11, wherein the rolling time window is defined by a predefined number of days preceding a current date.

14. (canceled)

15. (canceled)

16. A software as a service (SaaS) management platform (SMP) implemented in a cloud resource having at least one server computer and at least one storage device, the SMP being accessible over the Internet by a plurality of customers that utilize services of the SMP, the SMP comprising:
a connector interface for managing access credentials to customer event data collected by a SaaS of a target customer of the SMP, the target customer event data is generated through use of the SaaS by users of the target customer;
a human resources (HR) connector that accesses, over the Internet, an API of an HR SaaS application to obtain org chart data for the target customer, wherein the SMP uses the org chart data to automatically define a plurality of personnel segments of the target customer;
a scheduler configured to periodically trigger the connector interface to access said customer event data for the target customer and for other customers of the SMP;
wherein said customer event data is processed by the SMP into customer usage data that is descriptive of use of the SaaS,
an anonymizer for processing the customer usage data, the anonymizer is configured to strip customer identifying information related to the customers but retains data that is descriptive of use of the SaaS by users of the customers;
a benchmarking backend that is processed responsive to a request by the target customer, the benchmarking backend is configured to access customer usage data from a cohort group of customers, wherein the cohort group of customers is defined by anonymized customers having greater than a predefined minimum number of licenses for the SaaS, the benchmarking backend producing benchmark metrics that quantify use of the SaaS by users of customers in the cohort group;
a web server that provides over the Internet a graphical a user interface of the SMP, the graphical user interface includes a graphical segment control element providing access to said personnel segments of the target customer and enabling selection of a given personnel segment, the graphical user interface includes a benchmark button, wherein responsive to selection of said benchmark button and the selection of the given personnel segment, the graphical user interface provides said benchmark metrics in substantial real-time and further provides app metrics that quantify use of the SaaS by users of the target customer, and descriptive parameters for app metrics that are suggestive of possible optimizers available to the target customer for efficient use of the SaaS.

17. The SMP of claim 16, wherein the anonymizer is configured to remove customer names in the customer usage data and assign each customer in the customer usage data a unique identifier.

18. The SMP of claim 16, wherein the anonymizer is further configured to retain non-identifying characteristics of customers in the customer usage data.

19. The SMP of claim 16, wherein the benchmark metrics quantify use of the SaaS by defining a median use of the SaaS or use of one or more features of the SaaS by customers in the cohort group.

20. The SMP of claim 16, wherein the app metrics quantify use of the SaaS by defining a fraction or percentage of licensed users of the target customer that engaged with the SaaS or used one or more features of the SaaS.
